(19) United States
(12) Patent Application Publication
(10) Pub. No.: US 2015/0014097 A1
(43) Pub. Date: Jan. 15, 2015

(54) Descending Escape Equipment

(71) Applicant: Jui-Lon Chang, Tainan City (TW)

(72) Inventor: Jui-Lon Chang, Tainan City (TW)

(21) Appl. No.: 13/940,351

(22) Filed: Jul. 12, 2013

(51) Int. Cl. A62B 1/10

(52) U.S. Cl. CPC A62B 1/10
USPC 182/236

(57) ABSTRACT

A descending escape equipment comprises a descending device and a decelerating device. The descending device includes a shaft member which is wound around by two rope members in directions opposite to each other, so that while the shaft member is rotated to release one of the rope members, the other one of the rope members is retracted by the shaft member. The decelerating device includes a transmission member connected between the shaft member and the generator, and the shaft is being rotated to drive, via the transmission member, the generator that is loaded with the generator load for reducing a releasing speed and a retracting speed by a resistant moment of the generator generated by the generator load.

### FIELD OF THE INVENTION

The present invention relates to an escape rope, and more particularly to a descending escape equipment.

### BACKGROUND OF THE INVENTION

With progress of living standard, people in the city usually living in high-rise buildings instead of single-storey houses. Unfortunately, in spite that people take much precaution against an accident, such as a fire accident, there still always happen strategies that people can not escape from the high-rise building in the fire accident. In order to prevent such unfortunate accident from being occurred, now the high-rise building is usually not only provided with escape passages like an escape ladder but also is equipped with emergency equipments like an escape rope.

The escape rope, which is usually mounted outside of the building, provides for trapped people a way to escape where the escape rope is able to be descending to ground while the escape passages are being blocked. However, for operating a conventional escape rope to descend to the ground, it needs people or assistants to keep handling the escape rope to control a descending speed of the escape rope, it is thus not only inconvenient in use but also causes the possibility of a falling accident due to an improper handling.

Further, if a descending apparatus is extra equipped in the conventionally escape rope for the operation of the escape rope, the descending speed of the escape rope is hard to be controlled to thus cause the people uncomfortable and uneasy. Besides, once the power is failed, the descending apparatus on the contrary will block the people from the escape.

### SUMMARY OF THE INVENTION

Accordingly, it is an object of the present invention to provide a descending escape equipment which can automatically adjust a releasing speed of the escape rope according to different situations without the necessity of outside electrical power.

The present invention provides a descending escape equipment, comprising: a descending device including two rope members and a shaft member, wherein the shaft member is wound around by the rope members in directions opposite to each other, so that while the shaft member is rotated to release one of the rope members, the other one of the rope members is retracted by the shaft member, and each of the rope members has an attaching part for being attached to a safety buckle or a safety garment; and a decelerating device including a transmission member, a generator, and a generator load, wherein the transmission member is connected between the shaft member and the generator, wherein when the shaft member is being rotated to drive, via the transmission member, the generator that is loaded with the generator load for reducing a releasing speed and a retracting speed of the rope members by a resistant moment of the generator generated by the generator load.

According to an embodiment of the present invention, the shaft member is a prism member.

According to an embodiment of the present invention, the shaft member has a side wall portion to block at a lateral side of the rope member.

According to an embodiment of the present invention, the attaching part is a suspension ring.

According to an embodiment of the present invention, the transmission member is a transmitting gear set, the transmitting gear set includes a shaft gear and a generator gear which is engaged with the shaft gear, the shaft gear is connected with the shaft member and the generator gear is connected with the generator.

According to an embodiment of the present invention, the number of teeth on the shaft gear is greater than the number of teeth on the generator gear.

According to an embodiment of the present invention, the descending escape equipment further comprises a regulating device including a load adjustment, and the load adjustment is connected to the generator load to adjust the generator load.

According to an embodiment of the present invention, the regulating device includes a weight sensor for sensing a weight of a user, and the load adjustment is provided to adjust the generator load according to the weight of the user.

By means of technical means of the present invention, the releasing speed of the descending escape equipment can be automatically adjusted to help all ages of people including the aged or children to descend smoothly and safely in a decreasing speed to fled away from a fire scene. Further, the descending escape equipment is provided with two rope members which is used in turn to save the time for escaping, and thus to improve an escaping efficiency. In another embodiment, the descending escape equipment is allowed to adjust the resistant moment to the generator according the weight of the people waiting to escape to slow down the descending speed corresponding to the different weight's people.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic diagram of a descending escape equipment according to an embodiment of the present invention;

FIG. 2 is a schematic diagram of the descending escape equipment in a situation where one of the rope member is released according to the embodiment of the present invention; and

FIG. 3 is a schematic diagram of the descending escape equipment in a situation where the other one of the rope member is released according to the embodiment of the present invention.

### DETAILED DESCRIPTION OF THE PREFERRED EMBODIMENTS

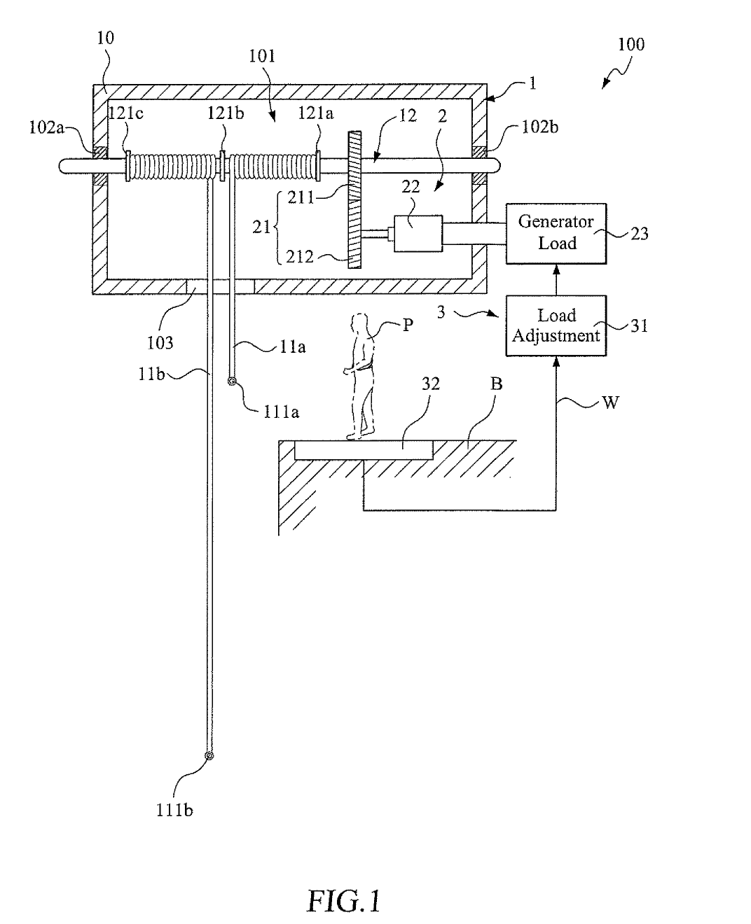

Please refer to FIG. 1, a descending escape equipment 100 according to an embodiment of the present invention includes descending device 1, a decelerating device 2, and a regulating device 3.

The descending device 1 includes a case body 10, two rope members 11a and 11b, and a shaft member 12. The case body 10 is provided to connect with a building B and is provided with a mounting space 101. The shaft member 12 is mounted in the mounting space 101 and is supported by bearings 102a and 102b in the case body 10 for the rotation. The two rope members 11a and 11b are provided to wind around the shaft member 12 in directions opposite with each other, and are being extended through an opening 103 to an outside of the case body 10. While the shaft member 12 is rotated to release one of the rope members 11a (11b), the other one of the rope members 11b (11a) is retracted by the shaft member 12. For example, one of the rope members 11a winds clockwise around the shaft device 12 and the other one of the rope members 11b winds counterclockwise around the shaft device 12. Note that although the rope members 11a and 11b are separate members in the embodiment, the rope members 11a and 11b may be two ends of one rope in other embodiment, and it can achieve the same function if one of the rope members 11a (11b) can be released while the other one of the rope members 11b (11a) is retracted.

The rope members 11a and 11b are each provided with an attaching part 111a, 111b, such as a suspension ring, which is used for being attached to a safety buckle or a safety garment (not shown) to help people escaping. Besides, the shaft device 12 in the embodiment has side wall portions 121a, 121b, and 121c to block at lateral sides of the rope members 11a and 11b to prevent the rope members 11a and 11b from being deviated or interfered with each other during retracted or released.

The decelerating device 2 includes a transmission member 21, a generator 22, and a generator load 23. The transmission member 21 is connected between the shaft member 12 and the generator 22. The transmission member 21 in the embodiment is a transmitting gear set including a shaft gear 211 and a generator gear 212 which are engaged with each other. The shaft gear 211 is connected with the shaft member 12 and the generator gear 212 is connected with the generator 22, so that when the shaft member 12 is rotating, the generator 22 is driven by the shaft member 12 via the shaft gear 211 and generator gear 212 of the transmission member 21 and thus to generate electrical power to the generator load 23. In addition, it is preferred that the shaft member 12 is a prism member to provide a high connection strength for the connection between the transmission member 21 (the shaft gear 211) and the shaft member 12.

When the generator 22 runs, a resistant moment is correspondingly occurred to against the generator 22. And, higher the rotation speed of the generator 22 or the according generator load 23 is, the resistant moment becomes larger. The resistant moment will suppress the rotation speed of the generator 22 to thus reduce the retracting and releasing speed that is derived from the shaft member 12 retracted or released by the rope members 11a and 11b. In addition, it is preferred that the number of teeth on the shaft gear 212 is greater than the number of teeth on the generator gear 212, so that the generator 22 will be driven at a high rotation speed relative to the shaft member 12 to thus significantly slow down the retracting speed and releasing speed.

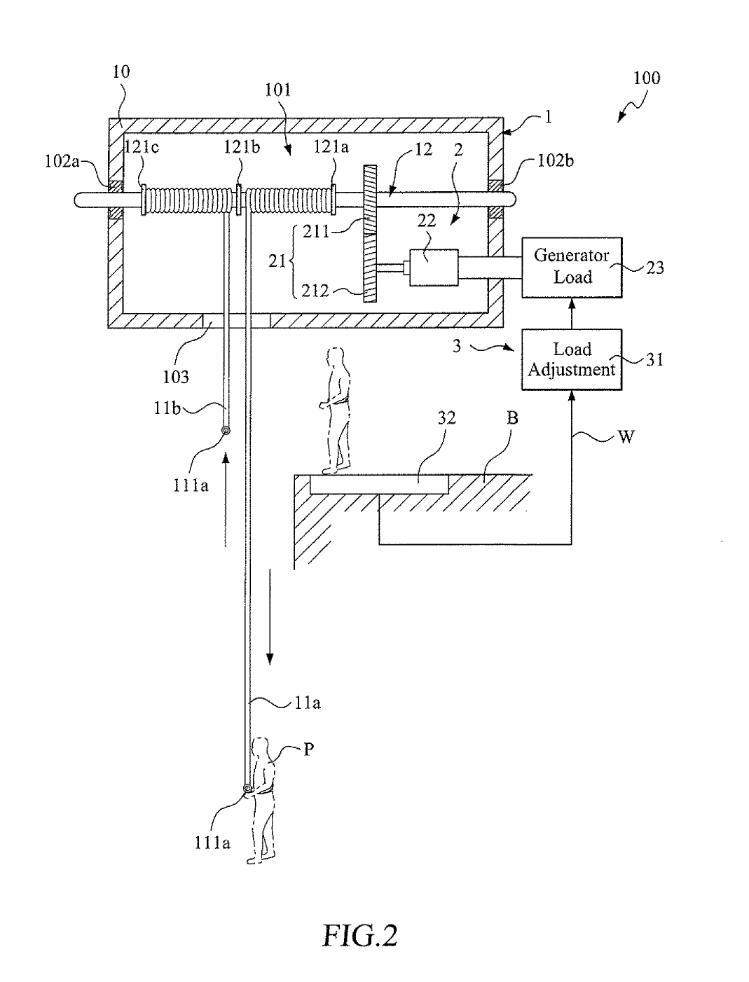

With above structure, when a user uses the rope member 11a to descend from the building B, as shown in FIG. 2, the rope member 11a is pulled down in a direction away from the shaft member 12 and the shaft member 12 is rotated to drive the generator 22 via the transmission member 21, so that the generator 22 generates an electrical power to the generator load 23. And, higher the descending speed is, the rotation speed of the generator 22 is increased, and thus the larger resistant moment will be generated. Then, the resistant moment will reduce the releasing speed of the rope member 11a to help the people P to descend smoothly and safely with a decreasing speed.

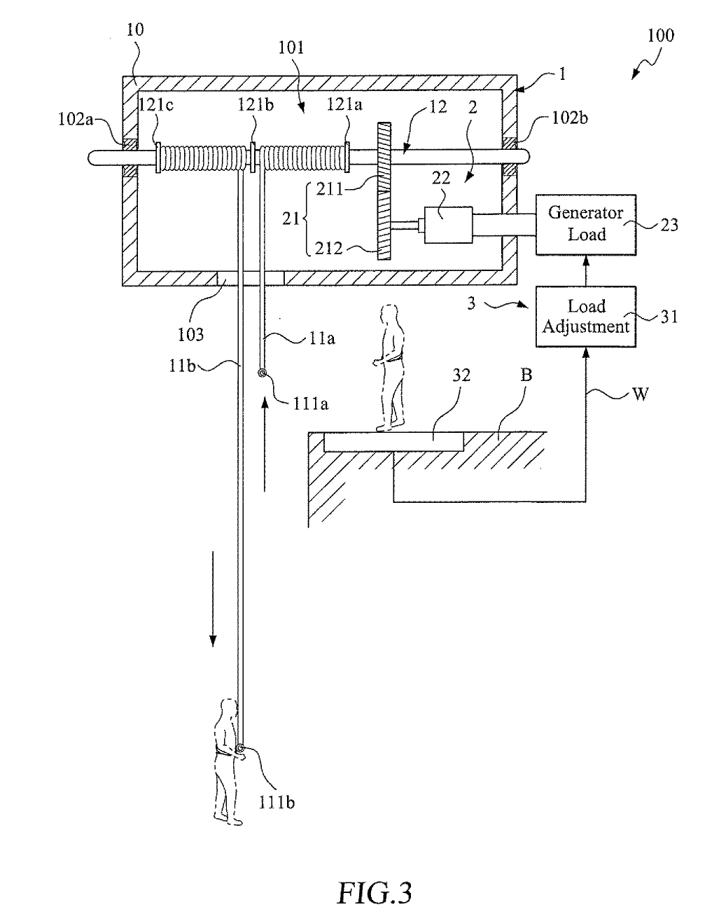

While the user has descended to the ground by using the rope member 11a, the other rope member 11b is retracted to an original height level where the rope member 11a is initially pulled down, and then the second user can use in turn. Alternatively, the rope member 11a is retracted by the second user to back to its original height level for the usage of the third user after the rope member 11b is pulled down to the ground, as shown in FIG. 3. According, the time for escaping is thus saved by using two rope members 11a and 11b in turn, and an escaping efficiency is improved.

In the embodiment, the regulating device 3 includes a load adjustment 31 and a weight sensor 32. The load adjustment 31 is connected to the generator load 23 to adjust the generator load 23 to thus adjust the releasing speed and the retracting speed of the rope members 11a and 11b. The weight sensor 32 is used for sensing a weight W of the user P, so that the load adjustment 31 adjusts the generator load 23 according to the weight W of the user P. The load adjustment 31 adjusts the generator load 23 in a relation of proportion to the weight W of the user P to thus provide a suitable deceleration for all people. Besides, the regulating device 3 is preferred to as a mechanical device or uses the electrical power generated by the generator 22 to prevent from being broken down due to a power failure.

With above structure, the descending escape equipment 100 according the present invention can help all ages of people P including aged people and children to descend smoothly and safely in a decreasing speed. Further, the time for escaping can be saved by using two rope members 11a and 11b in turn, and the escaping efficiency is also improved. Besides, the descending escape equipment 100 can adjust the resistant moment to the generator according the weight W of the user P, so as to provide a suitable deceleration for all people.

The above description should be considered as only the discussion of the preferred embodiments of the present invention. However, a person having ordinary skill in the art may make various modifications to the present invention. Those modifications still fall within the spirit and scope defined by the appended claims

What is claimed is:

1. A descending escape equipment, comprising:
a descending device including two rope members and a shaft member, wherein the shaft member is wound around by the rope members in directions opposite to each other, so that while the shaft member is rotated to release one of the rope members, the other one of the rope members is retracted by the shaft member, and each of the rope members has an attaching part for being attached to a safety buckle or a safety garment; and
a decelerating device including a transmission member, a generator, and a generator load, wherein the transmission member is connected between the shaft member and the generator, and the shaft member is being rotated to drive, via the transmission member, the generator that is loaded with the generator load for reducing a releasing speed and a retracting speed of the rope members by a resistant moment of the generator generated by the generator load.

2. The descending escape equipment as claimed in claim 1, wherein the shaft member is a prism member.

3. The descending escape equipment as claimed in claim 1, wherein the shaft member has a side wall portion to block at a lateral side of the rope member.

4. The descending escape equipment as claimed in claim 1, wherein the attaching part is a suspension ring.

5. The descending escape equipment as claimed in claim 1, wherein the transmission member is a transmitting gear set, the transmitting gear set includes a shaft gear and a generator gear which is engaged with the shaft gear, the shaft gear is connected with the shaft member and the generator gear is connected with the generator.

6. The descending escape equipment as claimed in claim 5, wherein the number of teeth on the shaft gear is greater than the number of teeth on the generator gear.

7. The descending escape equipment as claimed in claim 1, further comprising a regulating device including a load adjustment, the load adjustment is connected to the generator load to adjust the generator load.

8. The descending escape equipment as claimed in claim 7, wherein the regulating device includes a weight sensor for sensing a weight of a user, and the load adjustment is provided to adjust the generator load according to the weight of the user.
